(19) United States
(12) Patent Application Publication
(10) Pub. No.: US 2016/0093002 A1
(43) Pub. Date: Mar. 31, 2016

(54) Optimal Battery Pricing and Energy Management for Localized Energy Resources

(71) Applicant: NEC Laboratories America, Inc., Princeton, NJ (US)

(72) Inventors: Rakesh Patil, San Francisco, CA (US); Ratnesh Sharma, Fremont, CA (US); Soheil Eshghi, Philadelphia, PA (US)

(21) Appl. No.: 14/845,412

(22) Filed: Sep. 4, 2015

Related U.S. Application Data
(60) Provisional application No. 62/056,825, filed on Sep. 29, 2014.

(51) Int. Cl. G06Q 50/06

(52) U.S. Cl. CPC G06Q 50/06

(57) ABSTRACT

A method and system are provided for managing local energy resources of an energy system. The method includes determining, offline by a processor, an offline optimal resource allocation of the local energy resources using a Pontryagin Maximum Principle that involves a continuous, unbounded state. The method further includes determining, in real-time by the processor, a real-time optimal resource allocation of the local energy resources using offline-determined energy storage shadow pricing. The method also includes managing, by the processor, an allocation of the local energy resources in accordance with the offline optimal resource allocation and the real-time optimal resource allocation.

### RELATED APPLICATION INFORMATION

This application claims priority to provisional application Ser. No. 62/056,825 filed on Sep. 29, 2014, incorporated herein by reference.

### BACKGROUND

1. Technical Field

The present invention relates to signal processing, and more particularly to optimal battery pricing and energy management for localized energy resources.

2. Description of the Related Art

A microgrid resembles the electrical grid, but on a much smaller, localized scale. It uses localized generation (such as diesel generation) and storage, as well as the main electric grid, to service time varying local demand. A microgrid can include local renewable energy generation (e.g., photovoltaic generation), and a macrogrid connection.

Cost-optimal local dispatch management of a microgrid is challenging owing to the inherent uncertainties in demand, renewable generation, and even electric grid prices. Current work assumes one knows patterns of uncertainties or forecast the uncertainties using mathematical models in order to dispatch the local resources. Such models have to be redeveloped for every application as their nature is strongly dependent on the type and size of uncertainties. Furthermore, many of the current approaches are computationally intensive in real-time, requiring complex mathematical operations that may overwhelm simple controllers. Such computation and complex models, even when they result in superior operation disconnect the physical intuition on system operation from the actual results.

Thus, there is a need for a method and system for optimal battery pricing and energy management for localized energy resources.

### SUMMARY

These and other drawbacks and disadvantages of the prior art are addressed by the present principles, which are directed to optimal battery pricing and energy management for localized energy resources.

According to an aspect of the present principles, a method is provided for managing local energy resources of an energy system. The method includes determining, offline by a processor, an offline optimal resource allocation of the local energy resources using a Pontryagin Maximum Principle that involves a continuous, unbounded state. The method further includes determining, in real-time by the processor, a real-time optimal resource allocation of the local energy resources using offline-determined energy storage shadow pricing. The method also includes managing, by the processor, an allocation of the local energy resources in accordance with the offline optimal resource allocation and the real-time optimal resource allocation.

According to another aspect of the present principles, a system is provided for managing local energy resources of an energy system. The system includes a processor-based controller for determining offline an offline optimal resource allocation of the local energy resources using a Pontryagin Maximum Principle that involves a continuous, unbounded state, determining in real-time a real-time optimal resource allocation of the local energy resources using offline-determined energy storage shadow pricing, and managing an allocation of the local energy resources in accordance with the offline optimal resource allocation and the real-time optimal resource allocation.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary processing system 100 to which the present principles may be applied, according to an embodiment of the present principles;

FIG. 2 shows an exemplary system 200 for optimal battery pricing and energy management for localized energy resources, in accordance with an embodiment of the present principles;

FIG. 3 shows an exemplary offline portion 310 of a method 300 for optimal battery pricing and energy management for localized energy resources, in accordance with an embodiment of the present principles; and

FIG. 4 shows an exemplary online portion 350 of a method 300 for optimal battery pricing and energy management for localized energy resources, in accordance with an embodiment of the present principles.

### DETAILED DESCRIPTION OF PREFERRED EMBODIMENTS

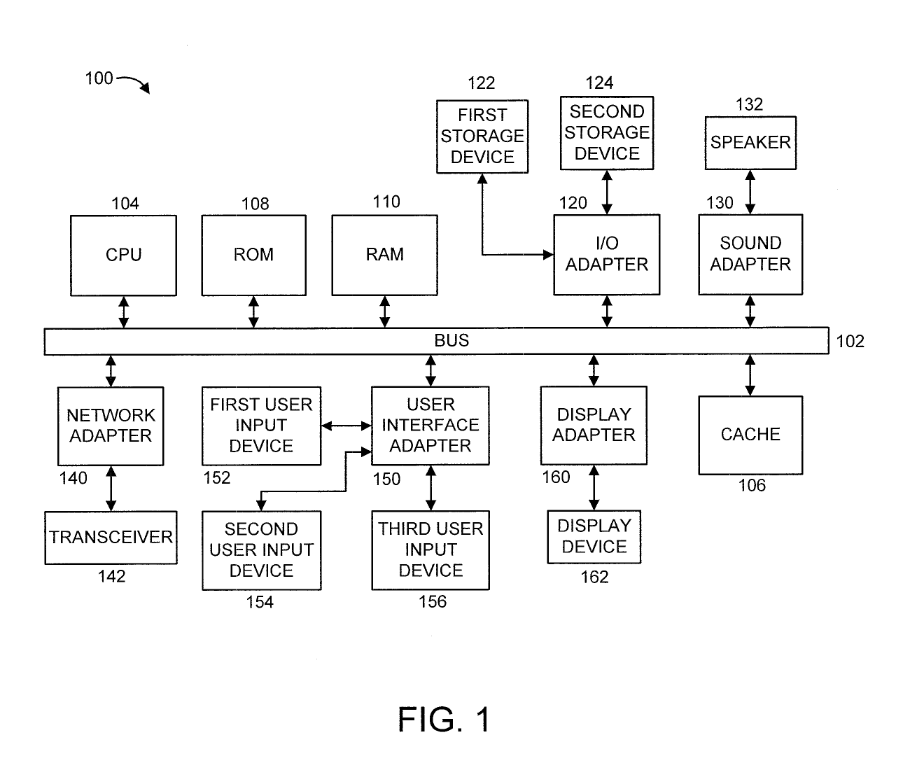

Referring now in detail to the figures in which like numerals represent the same or similar elements and initially to FIG. 1, a block diagram illustrating an exemplary processing system 100 to which the present principles may be applied, according to an embodiment of the present principles, is shown. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

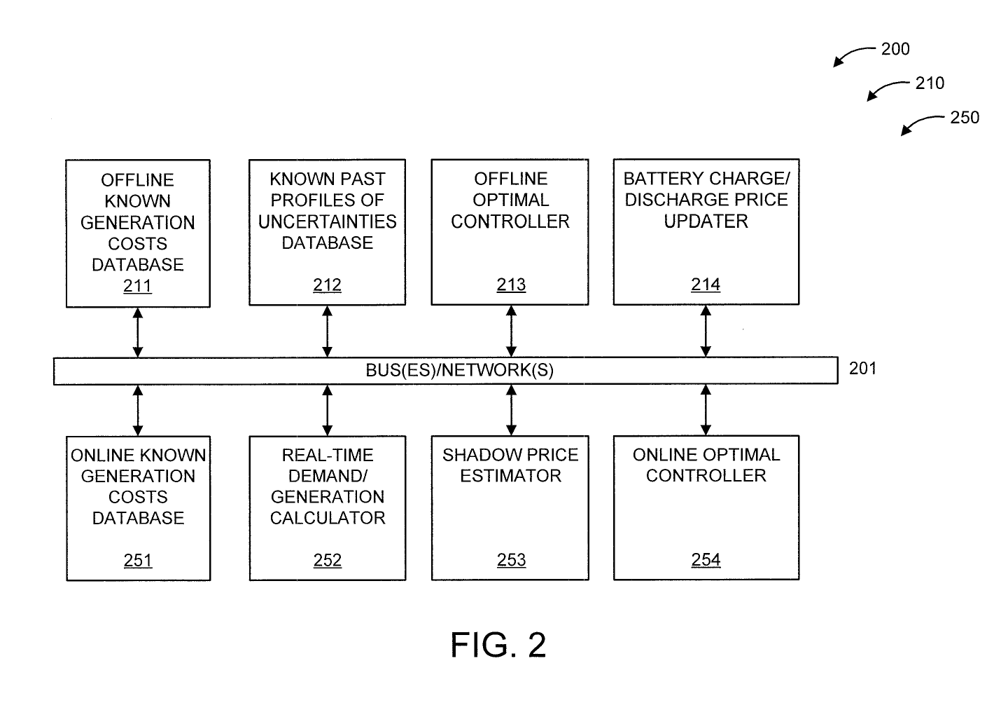

Moreover, it is to be appreciated that system 200 described below with respect to FIG. 2 is a system for implementing respective embodiments of the present principles. Part or all of processing system 100 may be implemented in one or more of the elements of system 200.

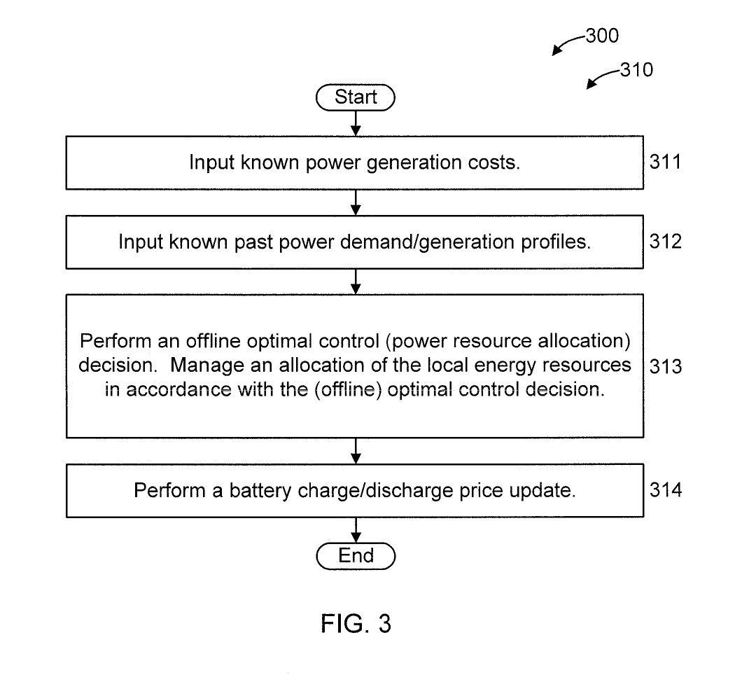

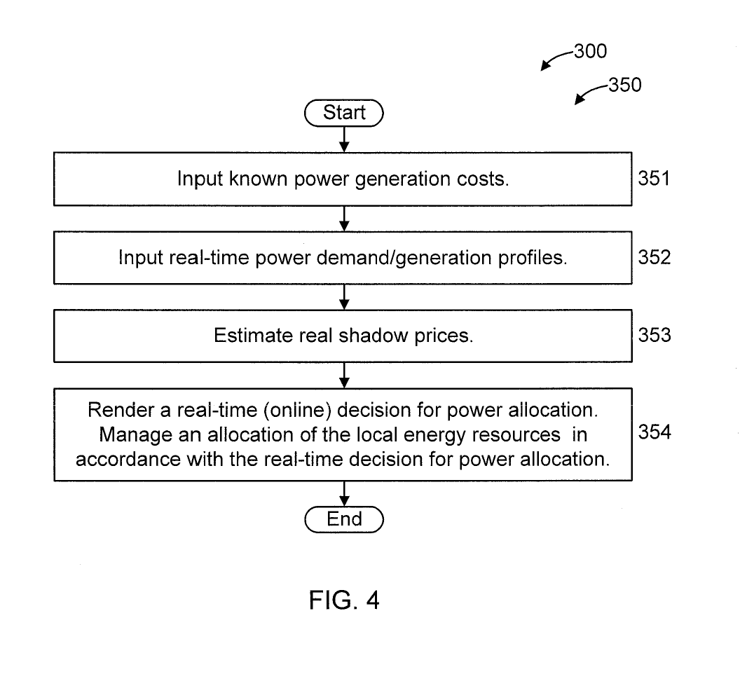

Further, it is to be appreciated that processing system 100 may perform at least part of the method described herein including, for example, at least part of method 300 of FIG. 3 and/or at least part of method 400 of FIG. 4. Similarly, part or all of system 200 may be used to perform at least part of method 300 of FIG. 3 and/or at least part of method 400 of FIG. 4.

FIG. 2 shows an exemplary system 200 for optimal battery pricing and energy management for localized energy resources, in accordance with an embodiment of the present principles. The system 200 includes an offline portion 210 and an online portion 250.

The offline portion 210 includes an offline known generation costs database 211, a known past profiles of uncertainties database 212, an offline optimal controller 213, and a battery charge/discharge price updater 214.

The online portion 250 includes an online known generation costs database 251, a real-time demand/generation calculator 252, a shadow price estimator 253, and an online optimal controller 254. The terms “controller” and “processor” are used interchangeably herein.

While shown as separate elements with one essentially for the online portion 210 and the other one essentially for the online portion 250, in an embodiment, the known generation costs database 211 and the known generation costs database 251 can be implemented using a single database used by both portions 210 and 250.

In the embodiment shown in FIG. 2, the elements thereof are interconnected by a bus(es)/network(s) 201. However, in other embodiments, other types of connections can also be used. Moreover, in an embodiment, at least one of the elements of system 200 is processor-based. Further, while one or more elements may be shown as separate elements, in other embodiments, these elements can be combined as one element. For example, while an offline optimal controller 213 and an online optimal controller 254 are shown in FIG. 2, in other embodiments, a single controller can be used to perform the functionalities described herein with respect to both controllers 213 and 254. The converse is also applicable, where while one or more elements may be part of another element, in other embodiments, the one or more elements may be implemented as standalone elements. These and other variations of the elements of system 200 are readily determined by one of ordinary skill in the art, given the teachings of the present principles provided herein, while maintaining the spirit of the present principles.

The elements of FIG. 2 are further described with respect to FIGS. 3 and 4 below.

FIGS. 3 and 4 show two parts of a method 300 that, when combined, generate an action profile (meaning a set of decisions for each element in the microgrid) at each time instance depending on the realization of renewable power and demand at each instance in time. The two parts of the method 300 include an offline portion 310 and an online portion 350.

Offline portion 310 is derived from a rigorous solution of an optimal control problem for a day in which the renewable generation and demand are already known. This solution yields an optimal a posteriori action profile for that day, as well as a rigorously defined shadow price for battery power that is used in the solution to compute the action profile. This shadow price characterizes the relative value of battery power over the course of a day (using a known value of the uncertainties).

In the online portion 350, these prices (i.e., the 24 hour trajectories of the shadow prices) are averaged over the course of a month, and this average price value is used to calculate the action profile for the current time-step in the day given realizations of the renewable power and demand at that particular time-step. The economic dispatch problem at each step using this average shadow price is myopic (i.e., independent of the past and future), and is evaluated in minimal time by applying a set of rules.

FIG. 3 shows an exemplary offline portion 310 of a method 300 for optimal battery pricing and energy management for localized energy resources, in accordance with an embodiment of the present principles.

At step 311, input known power generation costs. Such costs can include, but are not limited to, grid exchange costs, local conventional generation costs, and so forth.

At step 312, input known past power demand/generation profiles. Such profiles can include renewable power profiles, demand power profiles, and so forth.

At step 313, perform an offline optimal control (power resource allocation) decision. In an embodiment, step 313 involves an optimal economic dispatch (water-filling approach). In an embodiment, step 313 involves managing an allocation of the local energy resources (e.g., a microgrid or a portion of a microgrid) in accordance with the (offline) optimal control decision. Such allocation management can involve, but is not limited to, allocating all or a portion of the resources, reallocating all or a portion of the resources, selling energy at a given price, buying energy at a given price, and so forth. It is to be appreciated that the preceding management actions are illustrative and, thus, other actions can be taken in accordance with the teachings of the present principles, while maintaining the spirit of the present principles.

At step 314, perform a battery charge/discharge price update.

In an embodiment, one of more of the steps of offline portion 310 are performed iteratively. For example, upon performing a battery charge/discharge price update, the offline optimal control decision may be updated to reflect the price update.

FIG. 4 shows an exemplary online portion 350 of a method 300 for optimal battery pricing and energy management for localized energy resources, in accordance with an embodiment of the present principles.

At step 351, input known power generation costs. Such costs can include, but are not limited to, grid exchange costs, local conventional generation costs, and so forth.

At step 352, input real-time power demand/generation profiles. Such profiles can include renewable power profiles, demand power profiles, and so forth.

At step 353, estimate real shadow prices. In an embodiment, step 353 involves performing averaging. For example, in an embodiment, the shadow prices for a period of days is averaged to determine an average shadow price.

At step 354, render a real-time (online) decision for power allocation. In an embodiment, step 354 involves an optimal economic dispatch (water-filling approach). In an embodiment, step 354 involves managing an allocation of the local energy resources (e.g., a microgrid or a portion of a microgrid) in accordance with the (online) real-time decision for power allocation. Such allocation management can involve, but is not limited to, allocating all or a portion of the resources, reallocating all or a portion of the resources, selling energy at a given price, buying energy at a given price, and so forth. It is to be appreciated that the preceding management actions are illustrative and, thus, other actions can be taken in accordance with the teachings of the present principles, while maintaining the spirit of the present principles.

A further description will now be given of the optimal control (power resource allocation) decision 313 of the online portion 310 of method 300, in accordance with an embodiment of the present principles. The optimal control decision 313 is implemented by the offline optimal controller 213 of FIG. 2.

These blocks solve the optimal control problem, which in this case is an optimal resource allocation problem over the entire time horizon (of 24 hours). This decision is intuitively similar to filling water into a lake with an uneven bottom (a process known as water-filling). It takes as inputs, the trajectories of uncertainties (load, solar power, etc.) and initial values of the system states. The solution procedure utilizes the Pontryagin Maximum Principle (PMP). However, the PMP approach is not conducive to handling constraints on the system states. In accordance with the present principles, the constraints are handled by relaxing them to have a new continuous, unbounded state that is related to the original system state via a sigmoid function. Additionally, we exploit PMP approach to obtain insight on the shadow price of battery energy through the calculation of co-states. These two novel aspects of the optimal control decision block are enabled by rigorous mathematical derivations and make it an important key in the present principles. The price update strategy addresses the calculation of the shadow price in further detail.

The optimal control decision, combined with the price update strategy) gives, as output, the optimal power allocations, minimal costs of operation over the course of the day (given the trajectories of uncertainties), and the optimal shadow prices for battery power over the course of the time horizon in consideration.

A further description will now be given of the price update strategy 314 of the online portion 310 of method 300, in accordance with an embodiment of the present principles. The price update strategy 314 is implemented by the offline battery charge/discharge price updater 214 of FIG. 2.

The shadow-price of the battery energy is a proxy for the cost of charging or discharging the battery. Mathematically, it is the co-state associated with the battery state-of-charge in the PMP approach. In the price update block, the shadow-price of battery power at the final time in the horizon is shifted so that the battery state at the final time matches that of the initial time. This is necessary for any battery management policy that seeks to run continuously on a day-to-day basis and because the battery is an energy buffer rather than an energy source.

It is worth noting that as the battery state and the shadow price constitute a two-point boundary value problem given the optimal allocation rules from the optimal control solution, finding the correct shadow price at the terminal time, along with the known battery states at the terminal and initial time, uniquely determines the shadow price throughout the horizon. This terminal time shadow-price can be found via a shooting approach from the terminal time, whereby the state trajectory is calculated given the terminal time battery state and estimated shadow price, and the calculated estimated initial battery state is compared with the real initial battery state to decide how the estimated shadow price at terminal time should be updated. This is a sound strategy as less costly battery power leads to more battery depletion over the horizon, and vice versa.

A further description will now be given of the known past profiles 312 of the offline portion 310 of method 300, in accordance with an embodiment of the present principles. The known past profiles 312 are implemented by the known past profiles database 212 of FIG. 2.

Our approach does not depend on a specific modeling of the realizations of the uncertainties such as solar power or demand. This is an important key because modeling uncertainties is a challenging computational task.

We use realized day-profiles of Photovoltaic (PV) generation and demand from days in the past to calculate the optimal battery shadow-price trajectories for those days. There is a measure of periodicity in PV generation and demand on the scale of a day (due to the climate and resulting consumer habits) for a given geographical region, even though there may be quite significant differences in profile from day to day. This periodic nature helps utilize the shadow-prices in real-time decision making (FIG. 2).

A further description will now be given of the real-time demand/generation 352 of the online portion 350 of method 300, in accordance with an embodiment of the present principles. The real-time demand/generation 352 is implemented by the real-time demand/generation calculator 252 of FIG. 2.

The online portion of the algorithm only depends on the realization of the uncertainties (PV generation and demand) at the current decision instant, and thus does not need a modeling or forecasting element or any memory of past realizations within the same day. Of course, these approaches can be coupled with our basic model to fine-tune the shadow-prices used for the decision (for example, by changing estimating real-time shadow prices to a weighted average).

A further description will now be given of estimating real-time shadow prices 353 of the online portion 350 of method 300, in accordance with an embodiment of the present principles. The estimating real-time shadow prices 353 is implemented by the shadow price estimator 253 of FIG. 2.

This element takes as input the realized shadow prices from days past within the same month as calculated by repeated evaluation of the process in FIG. 1, for each day. The average shadow price for battery power over the period of a day is generated by averaging the shadow price at each time instant over the days for which the process in FIG. 1 is evaluated.

The basic model uses a mean of the shadow prices over all calculated days, but the weighting, and the method of averaging, can be improved by incorporating weights for the different days depending on forecasts and similarities in the profiles, etc.

A further description will now be given of the real-time decision 354 of the online portion 350 of method 300, in accordance with an embodiment of the present principles. The real-time decision 354 is implemented by the online optimal controller 254 of FIG. 2.

In an embodiment, the real-time decision block can be mathematically exactly the same as a single step of the optimal control decision. The real-time decision block takes as input the average shadow prices for battery power, the instantaneous costs from local and grid generation, and the realized PV generation and demand over that specific decision interval, and allocates power according to a myopic optimal dispatch decision, which is again intuitively similar to water-filling. This evaluation is based on checking a set of rules and requires minimal computational effort.

A description will now be given regarding some of the many attendant advantages of the present principles.

The present principles provide a flexible, state-based, and easily deployable microgrid management policy utilizing previous realizations of the microgrid's sources of uncertainty. The present principles are flexible in that they can incorporate various sources of uncertainty and different microgrid structures (configuration, size, and cost structure), meaning that they can be easily applied to manage the operation of any type of real-world microgrid. This innovative approach is state-based and the map of control decisions provide for physical intuition and meaningful energy analysis, as well as easy online implementation. Finally, our microgrid management solution is easily deployable, meaning that it is capable of running in real-time with low computational memory and time requirements.

The present principles use optimal control theory to characterize a simple decision rule for optimal energy management in each time period based on past realizations of the uncertainties. This decision rule rests on the definition of a shadow-price for battery power at each instance in time, based on previous realizations of the uncertainties. Assuming similar realizations of the uncertainty in the future, the shadow price of battery energy is compared to the price of energy from various resources resulting in simple decision-rules for optimal energy management policies.

The approach breaks down the computationally complex optimal control of microgrid resources over a time-horizon to a decision rule at each time-step that only requires as input the specific realizations of uncertainty at that time-step. Hence, there is no need to model the uncertainties. Thus the solution is easily deployable, and the decision depends only on the state of the system and the sources of uncertainty at that particular time. Furthermore, the problem is solved at a high level of generality, and the approach itself can scale with and encompass various microgrid structures, ensuring its flexibility. In addition to the features of a battery shadow price and time step wise decision making, state constraints (such as the constraint on battery energy capacity) are mathematically very challenging to handle and no general mathematical theory exists to simplify the field. Our approach by-passes the usual difficulties of finding an optimal state-based control, which usually requires a priori knowledge of points where the constraints are activated, with a simple analytic procedure for this particular problem, and proceeds to rigorously characterize a price for battery power at each moment in time.

A description will now be given regarding specific competitive/commercial values provided by the present principles.

The online segment of this approach is significantly less complex and thus faster than competing algorithms, as it requires minimal computation.

The resulting control strategy in our invention is optimal and results in the minimum cost or maximum revenue for a microgrid operator and/or customers. This cost performance is very close to the optimal performance if the uncertainties are known a priori guaranteeing the value proposition of our invention.

The present principles form an easily deployable approach that can be applied to manage any set of localized generation and storage resources. Our approach is generalized to incorporate multiple batteries and sources of generation, as well as various types of uncertainties such as renewable generation sources and time varying demand.

The approach does not depend on a specific stochastic modeling of generation and demand, and is thus immune to the errors resulting from simplification that are inherent to any such model. However, the approach itself can incorporate any set of stochastic generation models, as they can be used to generate profiles of demand and generation which can be fed into our battery shadow price calculator.

Finally, calculating a price for battery power allows the microgrid to calculate a price for additional generation/demand at each time-step, and this price can be used as a signal for demand shaping or demand response, which can provide an additional source of revenue for the microgrid operator or customers.

A further description will now be given regarding some of the features of the present principles and benefits provided thereby, in accordance with an embodiment of the present principles.

The application of PMP approach to optimal control of local energy resources is made possible by the sigmoid transformation of the state. This helps with handling the constraints and such an approach has not been applied to energy systems. The PMP approach enables myopic optimization requiring only current information, which means less computational memory requirements and faster computation without sacrificing the optimality of the solution.

In addition, the price interpretation of a Lagrange multiplier helps set up rules for real time implementation and results in a deployable solution which can be flexibly applied to a variety of microgrid configurations.

Storage shadow price update and calculation via shooting method enables the actual numerical evaluation of the price. The calculated shadow prices enable the rule evaluation with single time step information.

The present principles avoid uncertainty modeling. The present principles utilize past uncertainty data to get a spread of battery shadow prices which are averaged (or weighted averaged) and used for real-time decision making. Even in the real time our approach is very flexible in terms of the types of uncertainty considered and provides easy deployment of the solution because the uncertainties don't have to be modeled, resulting in significant computational advantages.

Real time decision making based on rules with a state based approach mean less computational memory, and less computation. The rules are derived from PMP with no numerical simplifications retaining rigorous optimality compared to other numerically intensive approaches.

The present principles can be extended to multiple devices and different cost structures or objectives due to fewer assumptions and numerical simplicity of the solution.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for managing local energy resources of an energy system, comprising:
determining, offline by a processor, an offline optimal resource allocation of the local energy resources using a Pontryagin Maximum Principle that involves a continuous, unbounded state;
determining, in real-time by the processor, a real-time optimal resource allocation of the local energy resources using offline-determined energy storage shadow pricing; and
managing, by the processor, an allocation of the local energy resources in accordance with the offline optimal resource allocation and the real-time optimal resource allocation.

2. The method of claim 1, wherein the local energy resources comprise a microgrid.

3. The method of claim 1, wherein determining the offline optimal resource allocation comprises relaxing constraints of the Pontryagin Maximum Principle using a sigmoid transformation.

4. The method of claim 1, further comprising determining pricing update information to provide updated pricing relative to a given time period, and wherein the offline optimal resource allocation is determined based on the updated pricing.

5. The method of claim 4, wherein the pricing update information is determined using any of a direct shooting method and an indirect shooting method.

6. The method of claim 1, wherein determining the offline optimal resource allocation comprises determining a myopic optimization at each of a plurality of time steps of a given time period.

7. The method of claim 1, wherein determining the offline optimal resource allocation comprises determining emissions cost, and wherein the offline optimal resource allocation is determined based on the emissions cost.

8. The method of claim 1, wherein the offline optimal resource allocation is determined based on known past profiles of power related uncertainties that include a measure of periodicity.

9. The method of claim 8, wherein the power related uncertainties relate to renewable energy generation, power demand, a cost of energy importation into the energy system, and a cost of energy exportation from the energy system.

10. The method of claim 1, wherein the local energy resources comprises at least one of a plurality of storage devices and a plurality of local power generation devices.

11. The method of claim 10, wherein at least some of the plurality of storage devices use different efficiency models.

11. The method of claim 10, wherein the plurality of local power generation devices are associated with any of convex cost structures and concave cost structures.

12. The method of claim 1, wherein the offline optimal resource allocation comprises an optimal shadow price associated with a plurality of storage devices comprised in the local energy resources.

13. The method of claim 1, wherein the offline-determined energy storage shadow pricing comprises a normal average or a weighted average of offline-determined shadow price trajectories.

14. The method of claim 1, wherein the real-time optimal resource allocation is determined using a state-based decision rule set.

15. The method of claim 14, wherein the state-based decision rule set includes at least one rule based on a comparison of a shadow price for energy storage and a marginal price of energy demand and energy generation at one or more of a plurality of time steps in a given time period.

16. The method of claim 14, wherein the real-time optimal resource allocation is determined using at least one rule that is evaluated using available information including current state information and without using past state information or predicted state information.

17. A non-transitory article of manufacture tangibly embodying a computer readable program which when executed causes a computer to perform the steps of claim 1.

18. A system for managing local energy resources of an energy system, comprising:
a processor-based controller for determining offline an offline optimal resource allocation of the local energy resources using a Pontryagin Maximum Principle that involves a continuous, unbounded state, determining in real-time a real-time optimal resource allocation of the local energy resources using offline-determined energy storage shadow pricing, and managing an allocation of the local energy resources in accordance with the offline optimal resource allocation and the real-time optimal resource allocation.

19. The system of claim 18, wherein said processor-based controller determines the offline optimal resource allocation by relaxing constraints of the Pontryagin Maximum Principle using a sigmoid transformation.

20. The system of claim 18, wherein said processor-based controller determines the offline optimal resource allocation by determining a myopic optimization at each of a plurality of time steps of a given time period.
